(19) United States
(12) Patent Application Publication
(10) Pub. No.: US 2011/0279096 A1
(43) Pub. Date: Nov. 17, 2011

(54) METHOD AND APPARATUS FOR POWERING A HIGH CURRENT SYSTEM FROM A RESISTIVE ELECTRICAL STORAGE DEVICE

(76) Inventor: Jeffrey L. Sonntag, Portland, OR (US)

(21) Appl. No.: 12/781,095

(22) Filed: May 17, 2010

(51) Int. Cl. H02J 7/00

(52) U.S. Cl. 320/166

(57) ABSTRACT

An apparatus includes an energy storage device having an equivalent series resistance coupled to a power supply node. The apparatus includes a first capacitor having an equivalent series resistance substantially lower than the equivalent series resistance of the energy storage device. In a first mode of the apparatus, the first capacitor is operative to receive charge from the power supply node. In a second mode of the apparatus, the first capacitor is operative to deliver current to a load. In a third mode of the apparatus, the power supply node is operative to deliver a second current to the load. The second current is substantially less than the first current.

### BACKGROUND

1. Field of the Invention

This application is related to integrated circuits and, more particularly, to providing power to integrated circuits.

2. Description of the Related Art

In a typical wireless sensor application, current consumption is very low most of the time, but infrequently requires a high current for a short period of time. For example, a wireless sensor device, e.g., a radio frequency identification (i.e., RFID) device, consumes less than approximately 1 μA of current. However, infrequently, (e.g., less than approximately 0.1% of the time) the device requires approximately 15 mA of current for approximately 10 ms. Energy harvesting techniques or a weak power source may be used to at least partially power such wireless sensor devices. A typical energy harvesting system converts energy from an external source (e.g., solar energy, thermal energy, energy from vibration, etc.) into electrical current or voltage, which is used to store the energy in a device (e.g., a battery or capacitor) for later use. In general, the rate of energy delivery from the storage device determines the size and cost of the system.

### SUMMARY

In at least one embodiment of the invention, an apparatus includes an energy storage device having an equivalent series resistance coupled to a power supply node. The apparatus includes a first capacitor having an equivalent series resistance substantially lower than the equivalent series resistance of the energy storage device. In a first mode of the apparatus, the first capacitor is operative to receive charge from the power supply node. In a second mode of the apparatus, the first capacitor is operative to deliver current to a load. In a third mode of the apparatus, the power supply node is operative to deliver a second current to the load. The second current is substantially less than the first current.

In at least one embodiment of the invention, a method includes storing energy in an energy storage device having an equivalent series resistance. The method includes, during a first time period, charging a first capacitor to a first voltage level. The first capacitor has an equivalent series resistance substantially less than the equivalent series resistance of the energy storage device. The method includes, during a second time period, delivering a first current from the first capacitor to a load. The method includes, during a third time period, delivering a second current to the load. The second current is substantially less than the first current.

In at least one embodiment of the invention, an apparatus includes at least one terminal and a circuit coupled to the power supply node and operative to generate a first control signal on the at least one terminal to enable charging of a capacitor with charge from a power supply node. The circuit is further operative to disable the charging of the capacitor and generate a second control signal on the at least one terminal to enable current delivery from the capacitor to a load after the capacitor is charged to a first voltage. The circuit is further operative to disable current delivery from the capacitor to thereby enable delivery of a second current to the load. The second current is substantially less than the current delivered to the load from the capacitor.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of a system including a weak or intermittent power source and a high equivalent series resistance energy storage device operative to provide power to a load system.

FIG. 2 illustrates an equivalent circuit diagram of an electrochemical double-layer capacitor.

FIG. 3 illustrates a functional block diagram of a system including a weak or intermittent power source, a high equivalent series resistance energy storage device, and a large capacitor operative to provide power to a load system.

FIGS. 4A and B illustrate functional block diagrams of systems including a weak or intermittent power source, a high equivalent series resistance energy storage device, and a large capacitor operative to provide power to a load system consistent with various embodiments of the invention.

FIG. 5 illustrates exemplary timing waveforms for the systems of FIG. 4 consistent with at least one embodiment of the invention.

FIG. 6 illustrates a functional block diagram of a system including a weak or intermittent power source, a high equivalent series resistance energy storage device, a voltage regulator, a charge pump, and a large capacitor operative to provide power to a load system consistent with at least one embodiment of the invention.

The use of the same reference symbols in different drawings indicates similar or identical items.

### DESCRIPTION OF THE PREFERRED EMBODIMENT(S)

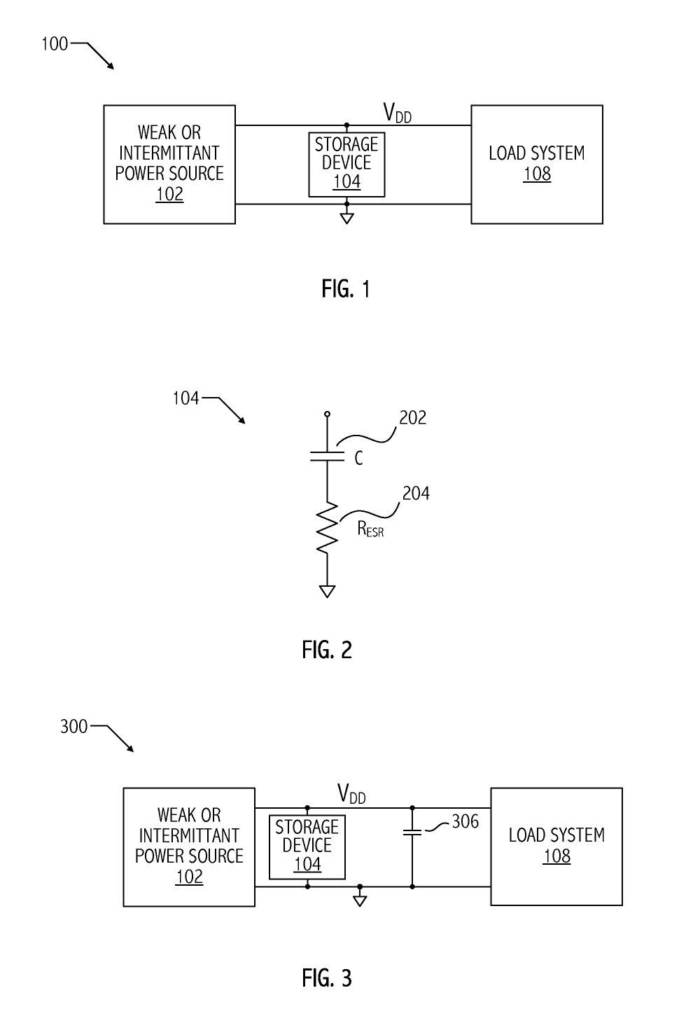

Referring to FIG. 1, in an exemplary system (e.g., system 100) a weak or intermittent power supply (e.g., power source 102, which in one embodiment provides a power level that is substantially less than a power level required for full operation of a load system) is coupled to a load system (e.g., load system 108) and an energy storage device (e.g., storage device 104). In at least one embodiment, power source 102 is an energy harvesting system that converts energy from an external source (e.g., solar energy, thermal energy, energy from vibration, etc.) into electrical current or voltage. In at least one embodiment, storage device 104 includes an electrochemical double-layer capacitor (i.e., ECDL, electric double-layer capacitor EDCL, pseudocapacitor, supercapacitor, supercap, or ultracapacitor), which is an electrochemical capacitor that has a high energy density. For example, a typical ECDL capacitor has an energy density on the order of thousands of times greater than a high capacity electrolytic capacitor of similar size. Referring to FIG. 2, an equivalent circuit for the ECDL capacitor includes the capacitance (e.g., capacitor 202 with a capacitance C) and an equivalent series resistance (e.g., resistor 204 having a resistance of R_{ESR}). The equivalent series resistance of a capacitor is the real resistive component of a complex impedance Z(ω)=R+jX(ω) of the capacitor, and is a measure of the lossiness of a real capacitor. An ideal capacitor is lossless and has an equivalent series resistance of zero. However, real capacitors are constructed of materials with finite electrical resistances, which cause real capacitors to have some resistance (e.g., resistances from leads, plates, and/or dielectric loss). The equivalent series resistance of a real capacitor behaves like a resistance in series with an ideal capacitance. Typical ECDL capacitors have an equivalent series resistance (e.g., greater than approximately 100-2000 Ohms) that is substantially greater than the equivalent series resistance of other types of capacitors (e.g., approximately 0.01-0.1 Ohms for ceramic capacitors and less than approximately 10 Ohms for electrolytic capacitors). Referring back to FIG. 1, in at least one embodiment, storage device 104 includes a small rechargeable battery (e.g., thin-film battery), which has a relatively high equivalent series resistance. In at least one embodiment of system 100, a small, inexpensive, battery having a high equivalent series resistance is used instead of storage device 104 and power source 102.

When load system 108 draws a high current (i.e., load system 108 initiates a high current event), the current is drawn through the equivalent series resistance of storage device 104 and a resulting voltage drop can be so large that the remaining voltage is insufficient to power load system 108. For example, if system 100 is a wireless sensor application that requires 15 mA and attempts to draw 15 mA from storage device 104 with an equivalent series resistance of approximately 100-2000 Ohms, the voltage at node V_{DD} would drop by at least 1.5 V. Depending on the supply voltage requirements of load system 108, system 100 may fail or not operate as intended or specified.

The large voltage drop at node V_{DD} of system 100 caused by attempting to draw a high current through a storage device having a high equivalent series resistance may be reduced by coupling a sufficiently large, low equivalent series resistance capacitor in parallel with storage device 104. Referring to FIG. 3, for example, a capacitor (e.g., capacitor 306) has an equivalent series resistance that is substantially lower than the equivalent series resistance of storage device 104, i.e., capacitor 306 has an equivalent series resistance that is at least one order of magnitude less than the equivalent series resistance of storage device 104. In at least one embodiment, capacitor 306 has a capacitance of at least I_{LOAD}×T/V_{DISCHARGE}, where I_{LOAD} is the load current, T is the time the system must run, and V_{DISCHARGE} is the maximum amount of voltage drop that can be tolerated. For example, if I_{LOAD} is 15 mA, T is 30 ms, and V_{DISCHARGE} is 1 V, then capacitor 306 should have a capacitance of at least 450 μF. Capacitor 306 can deliver power quickly over a short period of time. However, unlike an ideal capacitor, real capacitors may leak currents greater than an idle current (e.g. 1 μA), thus draining power and interfering with charging of the system. Typical ceramic capacitors have lower leakage than other capacitor types, but only have capacitances of a few micro-Farads (μF). Ceramic capacitors having capacitances of thousands of Farads have large volumes and are cost-prohibitive. Sufficiently large electrolytic capacitors are inexpensive and have relatively low equivalent series resistance, but leak even more than ceramic capacitors. Thus, techniques for improving system 100 that use a larger supercap, larger ceramic capacitors, or a larger energy harvester and that produce more power so that some can be drained by the leaky electrolytic capacitor, increase the system bill of material cost, system size, and system weight.

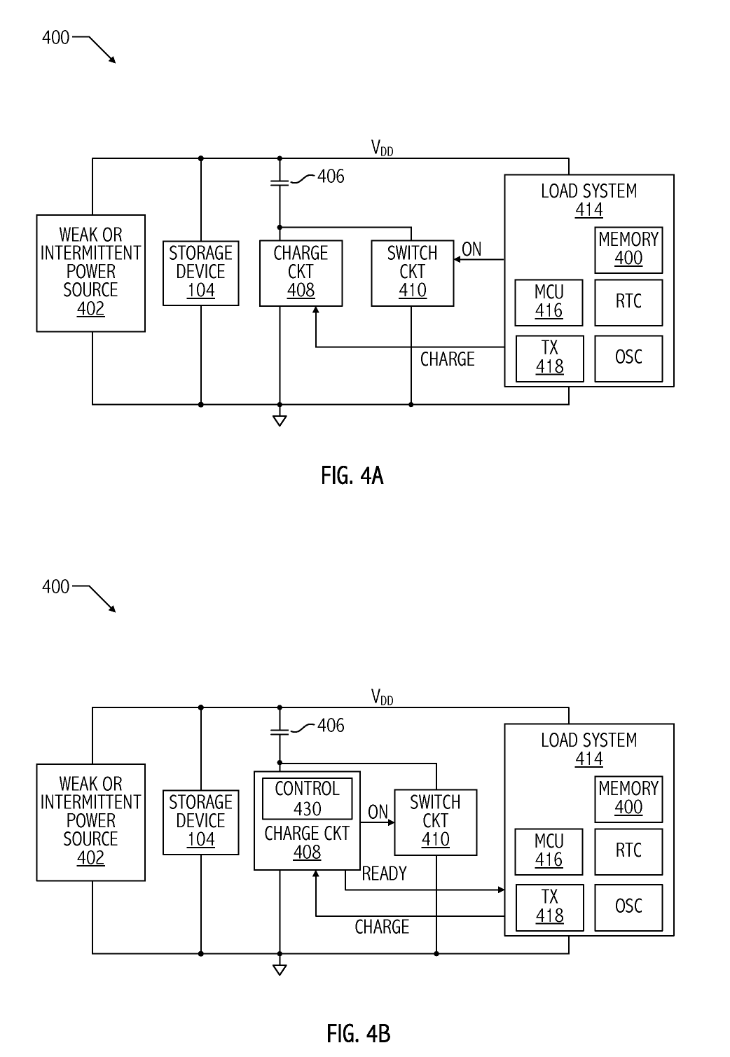

Referring to FIGS. 4A and 4B, in at least one embodiment, a system (e.g., system 400) experiences a voltage drop less than the voltage drop experienced by system 100 in response to a high current event. Similar to system 300, system 400 includes storage device 104, which has low leakage, and a high equivalent series resistance (e.g., ECDL or small battery) and large, leaky capacitor 406, which has a relatively low equivalent series resistance, i.e., capacitor 406 has an equivalent series resistance substantially lower than the equivalent series resistance of storage device 104. In at least one embodiment, capacitor 406 has a capacitance of at least I_{HIPOWER}×T_{HIPOWER}/V_{DISCHARGE}, where I_{HIPOWER} is the current delivered to the load, T_{HIPOWER} is the duration of the high current event, and V_{DISCHARGE} is the maximum amount of voltage drop that can be tolerated by the system. System 400 also includes charging circuit 408 and switch circuit 410 (e.g., one or more MOSFET devices configured as a switch), which are controlled by control signals ‘CHARGE’ and ‘ON,’ respectively. Those signals are generated by a control circuit (e.g., microcontroller unit 416 of load system 414). In operation, charging circuit 408 charges capacitor 406 to a voltage (e.g., approximately V_{DD}) just prior to a high-current event of the load system. Switch circuit 410 couples capacitor 406 effectively in parallel with load system 414 after capacitor 406 has been charged. Thus, system 400 reduces or eliminates the voltage drop experienced by the system of FIG. 3 when capacitor 406 is coupled fully in parallel with storage device 104. Accordingly, system 400 may cost less than system 300 because system 400 allows the use of weaker power source 402, weaker storage device 104, and/or more leaky capacitor 406 as compared to power source 102, storage device 104, and/or capacitor 306 of system 300.

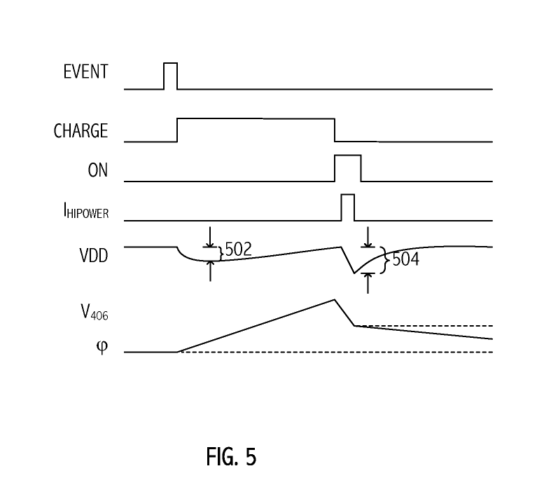

Referring to FIGS. 4A and 5, in at least one embodiment, load system 414 is a typical battery-powered application that spends a majority of time in a low-power sleep mode (i.e., the duty-cycle of a high-current mode of load system 414 is substantially lower than a duty cycle of the low-power sleep mode). In at least one embodiment, in the low-power sleep mode, load system 414 draws only a sleep-mode current from power source 402, which is substantially less than the current delivered to load system 414 in a high current mode. For example, system 400 may be a battery-operated wireless node (e.g., RFID, security, smart metering, or other suitable application) that wakes up from a sleep mode periodically, quickly performs measurements, transmits data, and then goes back into the sleep mode to conserve power. In at least one embodiment, load system 414 is an integrated circuit, which includes a radio-frequency transmitter (e.g., transmitter 418) and a microcontroller (e.g., microcontroller unit 416 configured consistent with the description below for a control circuit). During the low-power sleep mode and prior to wake-up of load system 414 (e.g., while EVENT=‘0,’), control signals open switch circuit 410 and disable charge circuit 408 (e.g., CHARGE=‘0’ and ON=‘0’), thereby configuring power source 402 to charge storage device 104 and provide a sleep-mode current to load system 414. At least one embodiment of load system 414 also includes a real-time clock (RTC) that is active so that microcontroller unit 416 can wake up periodically (e.g., EVENT=‘1’) using either an internal low power oscillator (OSC) or an external oscillator source. However, load system 414 may be any other suitable system that infrequently requires a high current for a short period of time and has a low sleep mode current.

In at least one embodiment of system 400, the difference between the voltage provided by storage device 104 and the voltage required by load system 414 has some margin for proper operation. The current drawn during the charging of capacitor 406 is controlled so that the voltage drop caused by the charging current is less than the margin voltage. In at least one embodiment of system 400, a short time before load system 414 draws a high current (e.g., before transmission operations in a wireless application), a control circuit (e.g., microcontroller unit 416) provides a control signal (e.g., CHARGE=‘1’) that causes charge circuit 408 to precharge capacitor 406. The duration of the active phase of the CHARGE signal must be long enough for charge circuit 408 to charge capacitor 406 almost completely to V_{DD} before switch circuit 410 is enabled. Charge circuit 408 limits the voltage drop due to charging capacitor 406 by charging the capacitor at a rate that makes the associated voltage drop (i.e., I_{CHARGE}×R_{ESR}, e.g., voltage drop 502) sufficiently small. Accordingly, system 400 continues to operate while charging capacitor 406. For example, if the equivalent series resistance of capacitor 406 is 1 kΩ and the margin voltage is approximately 1 V, then the charging current must be limited to less than approximately 1 mA to charge the capacitor to approximately V_{DD} (i.e., the top node of the capacitor has a voltage of approximately V_{DD} and the bottom node of the capacitor has a voltage approximately equivalent to ground). In at least one embodiment, charging circuit 408 is a switch with a series resistor or a current source or other controlled high resistance (e.g., resistance of several times as large as the equivalent series resistance of storage device 104).

Once capacitor 406 is charged, the CHARGE control signal causes the charging of capacitor 406 to cease (e.g., CHARGE=‘0’). In at least one embodiment of system 400, charge completion is detected by a comparator that compares the voltage on the bottom node of capacitor 406 to a small reference voltage. e.g., a voltage of approximately 2% of V_{DD}. Once the voltage on the bottom node of the capacitor drops below that threshold voltage, the capacitor is considered to be fully charged. In at least one embodiment, system 400 uses a timer (e.g., a timer implemented in microcontroller unit 416) to determine the duration of the charging period. At some time after capacitor 406 is charged, system 400 initiates a high-current event (i.e., enters a high-current mode). A control signal (e.g., ON=‘1’ provided by microcontroller unit 416) causes capacitor 406 to be effectively coupled in parallel with storage device 104. For example, when ON is high (i.e., ON=‘1’), a low resistance switch (e.g., switch circuit 410, which has R_{SWITCH}<<R_{ESR}) closes to couple capacitor 406 in parallel with storage device 104. When switch 410 is closed, the switch circuit provides a low equivalent series resistance path for the high-current event. Referring to FIG. 4B, rather than require load system 414 to generate a CHARGE signal that is active for a longest possible time, in at least one embodiment of system 400, the CHARGE control signal is a short pulse that initiates the charging. A local control circuit (e.g., control 430) senses the completion of the charging and generates the ON control signal that closes switch circuit 410 (e.g., ON=‘1’). The local control circuit generates a signal indicating that charging is complete (e.g., READY=‘1’) and delivers that signal to load system 414.

Due to the impedance ratio of capacitor 406 and storage device 104, capacitor 406 provides most of the current drawn by load system 414 during the high-current event (i.e., I_{DRAWN}). In at least one embodiment of load system 414, the duration of the charging period of capacitor 406 is substantially longer than the duration of the high-current event (e.g., T_{HIPOWER}). The voltage drop (i.e., dV, e.g., voltage drop 504) that occurs during the high current event is dV=T_{HIPOWER}×I_{DRAWN}/C₄₀₆. That is, I_{HIPOWER}×(R_{SWITCH}+T_{HIPOWER}/C₄₀₆) can be much less than I_{HIPOWER}×R_{ESR}. The voltage drop is less than drawing the current from storage device 104 and is within a voltage margin of system 400. After the high current event is complete, capacitor 406 is once again effectively decoupled from storage device 104 (e.g., in response to a sleep event, ON=‘0’) and switch circuit 410 is in an open state. Leakage may cause capacitor 406 to completely discharge before the next time it is needed (e.g., the next high-current event). If not, recharging capacitor 406 will consume less power than charging capacitor 406 from a zero charge state.

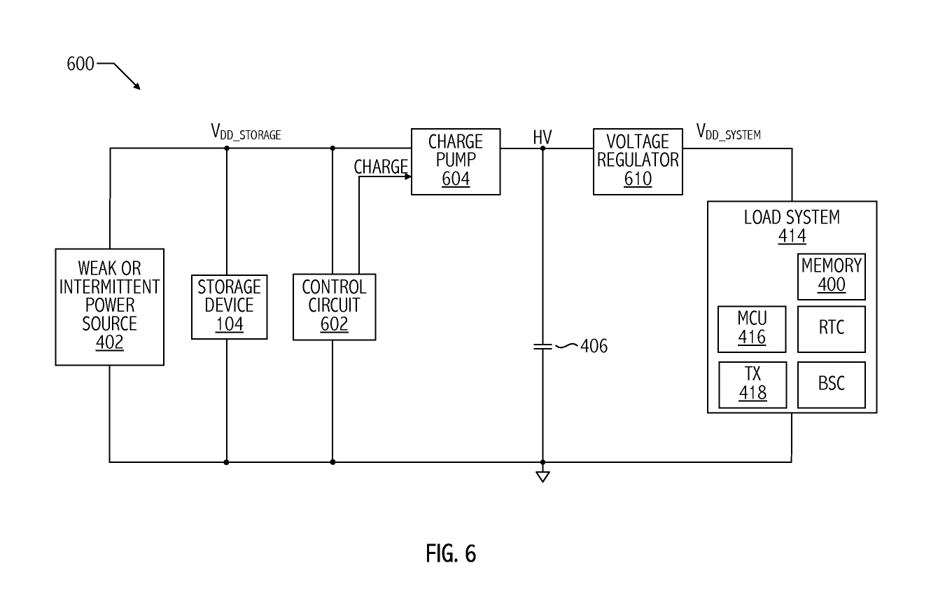

Referring to FIG. 6, in at least one embodiment, a system (e.g., system 600) does not couple capacitor 406 fully in parallel with the storage device 104 or load system 414. Instead, capacitor 406 receives charge from a charge pump (e.g., charge pump 604) to charge capacitor 406 to a voltage greater than V_{DD} (e.g., HV). A voltage regulator (e.g., voltage regulator 610) then provides a constant voltage level (e.g., a target value of V_{DD}_{_{—}}_{SYSTEM}) to the load circuit that is lower than the voltage level on capacitor 406. For example, charge pump 604 precharges capacitor 406 to 6V and voltage regulator 610 provides 3 V to power load system 414. When ON=‘1’, load system 414 of system 600 receives a full 3 V, rather than V_{DD}-dV, as illustrated in FIG. 5 for system 400 of FIG. 4, when ON=‘1’. In at least one embodiment of system 600, the voltage level provided to storage device 104 (e.g., V_{DD}_{_{—}}_{STORAGE}) and the voltage level provided to load system 414 (e.g., V_{DD}_{_{—}}_{SYSTEM}) are the same. However, in other embodiments of system 600, V_{DD}_{_{—}}_{STORAGE} differs from V_{DD}_{_{—}}_{SYSTEM} and those voltages are based on the needs and charge state of storage device 104 and the needs of load system 414, respectively.

In at least one embodiment of system 600, control circuit 602 includes a sleep mode timer function that wakes up periodically to enable charge pump 604 and provides control signals (e.g., an enable signal) (not shown) to voltage regulator 610 in response to the HV node being raised to a target voltage level. Accordingly, voltage regulator 610 provides V_{DD}_{_{—}}_{SYSTEM} to load system 414, which enables operation of load system 414. In at least one embodiment of system 600, load system 414 manipulates configuration information in control circuit 602 (e.g., configuration information that specifies a length of time to enable load system 414) via additional control channels (not shown).

In at least one embodiment, system 600 does not include control circuit 602 and load system 414 operates with a substantially low sleep mode current and provides control signals to voltage regulator 610 and charge pump 604, e.g., USE_HV and CHARGE, respectively. Voltage regulator 610 includes a direct connection to V_{DD}_{_{—}}_{STORAGE}. Load system 414 operates with a low current when not in the sleep mode and not during the high current event. When load system 414 deasserts USE_HV, voltage regulator 610 draws power directly from V_{DD}_{_{—}}_{STORAGE}. Prior to a high current event, load system 414 directly enables charge pump 604 using a CHARGE signal. After charging node HV to a target level, load system 414 initiates high current operation using the USE_HV signal.

Referring to FIGS. 4A, 4B and 6, at least one embodiment of system 400 requires a larger, more expensive capacitor, than the capacitor of at least one embodiment of system 600. In system 400, since load system 414 receives V_{DD}-dV, capacitor 406 must receive substantially more charge than would have been used by system 400 during a high current event (e.g., six times more charge when V_{DD} is approximately 3 V and load system 414 requires at least 2.5 V to operate). System 400 wastes a large portion of the power drawn from storage device 104 (e.g., approximately ⅚ ths). If capacitor 406 of system 400 is precharged to 6V and load system 414 requires approximately 2.5 V to operate, capacitor 406 can be substantially smaller than capacitor 406 of system 400 (e.g. seven times smaller). However, system 600 charges capacitor 406 to a voltage twice as high as the voltage that system 300 charges capacitor 306. Since capacitor storage is proportional to CV², system 600 has a modest power savings as compared to system 400. In addition, note that the voltage level of V_{DD} of system 400 depends upon the charge state of storage device 104 and temperature. In general, that voltage level may not be the same as a target voltage level of the initial value of V_{DD} for load system 414. For example, that mismatch may make it difficult or impossible for system 400 to operate when storage device 104 is only partially charged. In contrast, voltage regulator 610 of system 600 provides a value of V_{DD}_{_{—}}_{SYSTEM} that can be selected according to needs of load system 414, which may not match the fully or partially charged value of V_{DD}_{_{—}}_{STORAGE}. In addition, note that voltage regulator 610 provides a steadier output voltage than would otherwise be seen by load system 414.

While circuits and physical structures are generally presumed, it is well recognized that in modern semiconductor design and fabrication, physical structures and circuits may be embodied in computer-readable descriptive form suitable for use in subsequent design, test, or fabrication stages. Structures and functionality presented as discrete components in the exemplary configurations may be implemented as a combined structure or component. The invention is contemplated to include circuits, systems of circuits, related methods, and tangible computer-readable medium having encodings thereon of such circuits, systems, and methods, all as described herein, and as defined in the appended claims. As used herein, a computer-readable medium includes at least disk, tape, or other magnetic, optical, semiconductor (e.g., flash memory cards, ROM), or electronic storage medium.

The description of the invention set forth herein is illustrative, and is not intended to limit the scope of the invention as set forth in the following claims. Variations and modifications of the embodiments disclosed herein, may be made based on the description set forth herein, without departing from the scope and spirit of the invention as set forth in the following claims.

What is claimed is:

1. An apparatus comprising:
an energy storage device having an equivalent series resistance coupled to a power supply node; and
a first capacitor having an equivalent series resistance substantially lower than the equivalent series resistance of the energy storage device, wherein in a first mode of the apparatus, the first capacitor is operative to receive charge from the power supply node, in a second mode of the apparatus, the first capacitor is operative to deliver current to a load, and in a third mode of the apparatus, the power supply node is operative to deliver a second current to the load, the second current being substantially less than the first current.

2. The apparatus, as recited in claim 1, wherein the apparatus is operative to enter the first mode of the apparatus from the third mode of the apparatus in response to a wake-up event, the apparatus is operative to enter the second mode of the apparatus from the first mode of the apparatus in response to the first capacitor being sufficiently charged, and the apparatus is operative to enter the third mode of the apparatus from the second mode of the apparatus in response to a sleep event.

3. The apparatus, as recited in claim 1, wherein the apparatus is operative in the first mode of the apparatus for a substantially longer time than the apparatus is operative in the second mode of the apparatus and the apparatus is operative in the third mode of the apparatus for a substantially longer time that the apparatus is operative in the second mode.

4. The apparatus, as recited in claim 1, further comprising:
a charging circuit responsive to a value of a first control signal to enable charge delivery to the first capacitor in the first mode of the apparatus.

5. The apparatus, as recited in claim 4, further comprising:
a switch responsive to a first value of a second control signal to couple the first capacitor effectively in parallel with the energy storage device and to deliver current to the load in the second mode of the apparatus.

6. The apparatus, as recited in claim 5, further comprising:
a control circuit responsive to provide the first control signal before the second control signal.

7. The apparatus, as recited in claim 1, wherein the load comprises:
a load circuit operative in a low-power sleep mode and operative in a high current mode in the second mode of the apparatus, the high-current mode having a duty cycle substantially lower than a duty-cycle of the low-power sleep mode.

8. The apparatus, as recited in claim 1, further comprising:
a charge pump operative to deliver charge from the power supply node to the first capacitor in the first mode; and
a voltage regulator operative to deliver current from the first capacitor to the load in the second mode.

9. The apparatus, as recited in claim 8, wherein the first capacitor is charged to a first voltage in the first mode and the load receives a second voltage from the voltage regulator in the second mode.

10. The apparatus, as recited in claim 1, further comprising:
a weak or intermittent power source coupled to the power supply node and responsive to provide charge to the energy storage device via the power supply node.

11. The apparatus, as recited in claim 1, wherein the equivalent series resistance of the energy storage device is at least one order of magnitude greater than the equivalent series resistance of the first capacitor.

12. The apparatus, as recited in claim 1, wherein the energy storage device includes at least one of an electrochemical double-layer (ECDL) capacitor and a thin-film battery.

13. The apparatus, as recited in claim 1, wherein the load includes a radio frequency (RF) transmitter.

14. The apparatus, as recited in claim 1, wherein the first capacitor has a capacitance of at least I_{HIPOWER}×T_{HIPOWER}/V_{DISCHARGE}, where I_{HIPOWER} is the current delivered to the load, T_{HIPOWER} is the duration of the second mode of the apparatus, and V_{DISCHARGE} is the maximum amount of voltage drop that can be tolerated by a system including the load.

15. A method comprising:
storing energy in an energy storage device having an equivalent series resistance;
during a first time period, charging a first capacitor to a first voltage level, the first capacitor having an equivalent series resistance substantially less than the equivalent series resistance of the energy storage device;
during a second time period, delivering a first current from the first capacitor to a load; and
during a third time period, delivering a second current to the load, the second current being substantially less than the first current.

16. The method, as recited in claim 15, further comprising:
operating the load in a high-current mode during the second time period responsive to current delivered from the first capacitor.

17. The method, as recited in claim 16, further comprising:
operating the load in a low-power sleep mode during the third time period;
waking the load from the low-power sleep mode of the third time period and initiating the first time period; and
initiating the second time period after the capacitor is charged to the first voltage level.

18. The method, as recited in claim 15, wherein the first time period is substantially longer than the second time period and a voltage drop on the power supply node due to charging the first capacitor is sufficiently small.

19. The method, as recited in claim 15, wherein the first voltage level is greater than a voltage level on the energy storage device.

20. The method, as recited in claim 15, wherein the delivering the first current includes regulating the first voltage level of the first capacitor to a second voltage level of the load.

21. The method, as recited in claim 15, wherein the energy storage device includes at least one of an electrochemical double-layer (ECDL) capacitor and a thin-film battery.

22. An apparatus comprising:
at least one terminal; and
a circuit operative to generate a first control signal on the at least one terminal to enable charging of a capacitor with charge from a power supply node, wherein the circuit is further operative to disable the charging of the capacitor and generate a second control signal on the at least one terminal to enable current delivery from the capacitor to a load after the capacitor is charged to a first voltage, and wherein the circuit is further operative to disable current delivery from the capacitor to thereby enable delivery of a second current to the load, the second current being substantially less than the current delivered to the load from the capacitor.

23. The apparatus, as recited in claim 22, wherein the first control signal enables the charging for a substantially greater period of time than the second control signal enables the current delivery from the capacitor.

24. The apparatus, as recited in claim 22, further comprising:
an energy storage device coupled to the power supply node and operative to provide charge to the capacitor, the energy storage device having an equivalent series resistance substantially greater than the equivalent series resistance of the capacitor; and
a weak or intermittent power source coupled to the power supply node and responsive to deliver charge to the energy storage device.

25. The apparatus, as recited in claim 24, further comprising:
the capacitor;
a charging circuit responsive to the first control signal to charge the capacitor to the first voltage; and
a switch circuit responsive to the second control signal to enable current delivery from the capacitor to the circuit.

26. The apparatus, as recited in claim 22, wherein the energy storage device includes at least one of an electrochemical double-layer (ECDL) capacitor and thin-film battery.

27. The apparatus, as recited in claim 22, further comprising:
an integrated circuit including the circuit and the at least one terminal, wherein the integrated circuit includes a radio frequency (RF) transmitter operative in a high-current mode during the current delivery from the capacitor and operative in a low-power sleep mode for a period of time substantially greater than a period of time associated with the high-current mode.
